(19) United States
(12) Patent Application Publication
(10) Pub. No.: US 2014/0013516 A1
(43) Pub. Date: Jan. 16, 2014

(54) Gardening Implement

(71) Applicant: Pinky Fredericks, New Brighton, PA (US)

(72) Inventor: Pinky Fredericks, New Brighton, PA (US)

(21) Appl. No.: 13/938,757

(22) Filed: Jul. 10, 2013

Related U.S. Application Data
(60) Provisional application No. 61/669,789, filed on Jul. 10, 2012.

(51) Int. Cl. B26B 13/22; A01G 3/06

(52) U.S. Cl. CPC B26B 13/22; A01G 3/06
USPC 7/116; 30/244

(57) ABSTRACT

A gardening implement including both a pruning feature and a digging feature in a single hand-held tool is disclosed. The gardening implement includes a handle portion adapted for accommodating the fingers of a user connected to a blade portion capable of providing a scissoring or cutting action. The blade portion of the apparatus also includes a curvature capable of allowing a scooping or digging action. The handle portion may further include a flattened region adapted for allowing a user to press or push against to urge the blade portion into the ground in a digging action.

### CROSS-REFERENCE TO RELATED APPLICATION

The present application claims priority to U.S. Provisional Application Ser. No. 61/669,789, filed Jul. 10, 2012, entitled “Gardening Implement”, the entire disclosure of which is hereby incorporated by reference.

### BACKGROUND OF THE INVENTION

1. Field of the Invention

The present invention relates generally to gardening implements and, more particularly, to an apparatus having dual cutting and digging functionality.

2. Description of Related Art

Many different tools are used in household gardening to accomplish a variety of tasks, such as pruning, trimming, shoveling, and digging. Often a scissor device or pruners are required for cutting and trimming, whereas a trowel device is used for small digging or shoveling projects. In many instances, a gardening project changes scope once it is initiated. For example, if a gardener takes a pair of pruners to the garden for a pruning project, the gardener will also often find the need for a trowel or other digging implement to remove a weed or the like that becomes known once the pruning has begun. Similarly, if a gardener takes a trowel to the garden to dig weeds they will often find the need for a pruning device to trim plants once the project is initiated.

For the sake of convenience, it is desirable to provide a single hand-held garden tool that is useful for both pruning/trimming tasks and digging tasks.

### SUMMARY OF THE INVENTION

The present invention has been developed in view of the foregoing problems and other deficiencies of previous garden implements. The apparatus of the present invention includes both a pruning feature and a digging feature in a single hand-held tool. In one embodiment, the apparatus includes a hand-held portion adapted for accommodating the fingers of a user connected to a blade portion capable of providing a scissoring or cutting action. The blade portion of the apparatus also includes a curvature capable of allowing a scooping or digging action, and the hand-held portion may further include a flattened region adapted for allowing a user to press or push against to urge the blade portion into the ground in a digging action.

In accordance with an embodiment of the invention, a gardening implement includes a blade portion having a first engageable blade having a first sharpened region extending between a first tip portion and a pivot, and a second engageable blade having a second sharpened region extending between a second tip portion and the pivot. The first engageable blade and the second engageable blade are pivotally connected at the pivot. Each of the first sharpened region and the second sharpened region include a thickened region having a concave curved profile, and when the first sharpened region of the first engageable blade is provided in contact with the second sharpened region of the second sharpened blade, the blade portion forms a scoop. When the first tip portion of the first engageable blade is provided in contact with the second tip portion of the second engageable blade, the engaged first tip portion and second tip portion of the blade portion form a digging tip portion. The garden implement also includes a handle portion connected to the blade portion. The handle portion includes a first handle portion connected to the first engageable blade and a second handle portion connected to the second engageable blade. The handle portion defines a first grasping portion defined within a portion of the first handle portion and the second handle portion, and the handle portion includes a second grasping portion disposed along an outer surface of the first handle portion and an outer surface of the second handle portion.

In certain configurations, when the first sharpened region of the first engageable blade is provided in contact with the second sharpened region of the second engageable blade, the blade portion forms a generally semi-spherical cross-section. The first grasping portion may define an opening hole in the first handle portion suitable for receiving a user's finger therein, and the first grasping portion may also define a second opening hole in the second handle portion suitable for receiving a user's finger therein. The second grasping portion may include a grippable region having a plurality of indentations for receiving a user's fingers therein. The second grasping portion may include a tackifier. Alternatively, or in addition, the second grasping portion may also include foam padding.

The first handle portion may include an extended portion, and the second handle portion may include a second extended portion, each of the extended portion and the second extended portion having a thickened region for receiving a user's palm. In certain embodiments, the blade portion is longer than the handle portion. In some configurations, the blade portion and the handle portion taken together define an overall length and a length of the blade portion is from about 60% to about 80% of the overall length of the blade portion and handle portion taken together.

The first sharpened region and the second sharpened region may be adapted for cutting garden material. The scoop may be adapted for holding dirt or other like material. The digging tip portion may be suitable for penetrating soil. The handle portion may include a generally flattened region for allowing a user's palm to be pressed thereagainst.

In certain configurations, each of the first engageable blade and the second engageable blade include a generally straightened region and a curved region. In one configuration, the generally straightened region is adjacent the pivot. In another configuration, the first engageable blade includes the curved region adjacent the first tip portion and the second engageable blade includes the curved region adjacent the second tip portion. The first engageable blade and the second engageable blade may each include a thickened region having the same concave curved profile. Alternatively, the first engageable blade may include a thickened region having a first concave curved profile and the second engageable blade may include a thickened region having a second concave curved profile, wherein the first concave curved profile is different from the second concave curved profile.

### BRIEF DESCRIPTION OF THE DRAWINGS

FIG. 1 is a perspective view of a gardening implement employing the cutting action in accordance with the present invention shown.

FIG. 2 is a perspective view of the gardening implement of FIG. 1 shown employing the digging action in accordance with an embodiment of the present invention.

FIG. 3 is perspective side view of the gardening implement of FIG. 1 having the blade portion disposed in a closed position in accordance with an embodiment of the present invention.

FIG. 3A is an alternative side view of a gardening implement having the blade portion disposed in a closed position in accordance with an embodiment of the present invention.

FIG. 4 is front view of the gardening implement of FIG. 1 having the blade portion disposed in an open position in accordance with an embodiment of the present invention.

FIG. 4A is an alternative front view of a gardening implement having the blade portion disposed in an open position in accordance with an embodiment of the present invention.

FIG. 4B is a front view of the gardening implement of FIG. 4A having the blade portion disposed in a closed position in accordance with an embodiment of the present invention.

FIG. 5 is a front view of the gardening implement of FIG. 1 having the blade portion disposed in a closed position in accordance with an embodiment of the present invention.

FIG. 6 is a rear view of the gardening implement of FIG. 1 having the blade portion disposed in a closed position in accordance with an embodiment of the present invention.

### DETAILED DESCRIPTION OF THE PREFERRED EMBODIMENTS

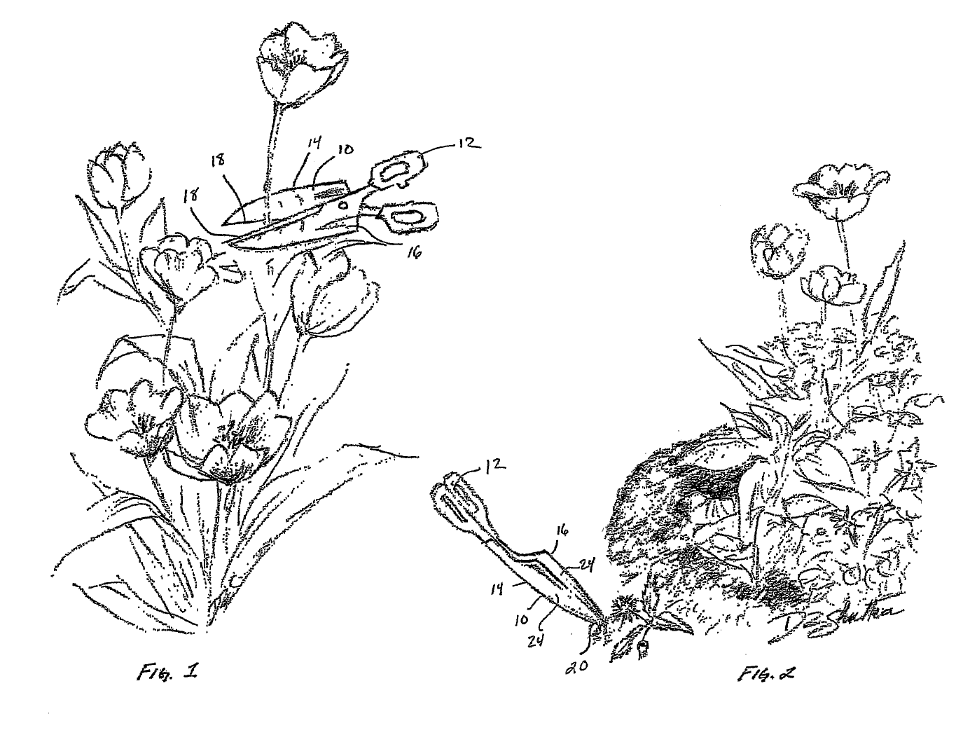

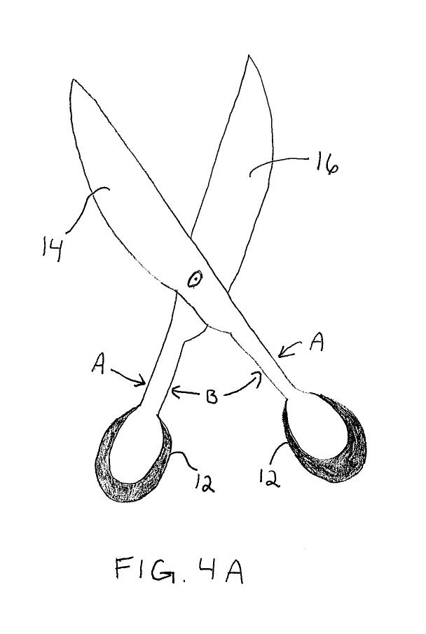

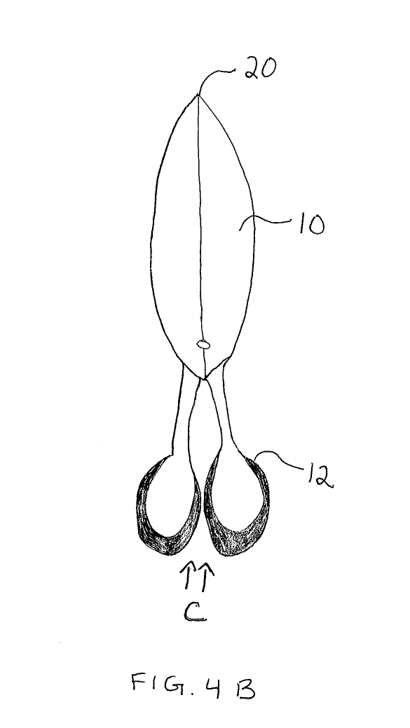

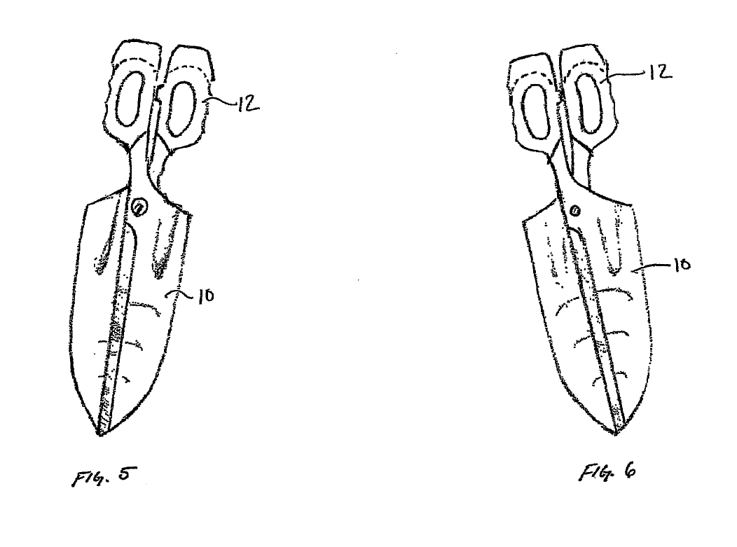

As shown in FIGS. 1-6, the gardening implement of the present invention includes a blade portion 10 and a handle portion 12 connected to the blade portion 10. In one configuration, the blade portion 10 includes two engageable blades 14, 16 each having a sharpened region 18 and engageable therewith to perform a cutting action. In a further configuration, the engageable blades 14, 16 of the blade portion 10 are adapted to transition from a first open position in which the engageable blades 14, 16 are spaced apart from each other, as shown in FIG. 4, to a second closed position in which the engageable blades 14, 16 are provided substantially adjacent each other, as shown in FIGS. 5-6. Specifically, the sharpened region 18 of the first engageable blade 14 is spaced apart from the sharpened region 18 of the second engageable blade 16 in the open first position, and the sharpened region 18 of the first engageable blade 14 is disposed adjacent the sharpened region 18 of the second engageable blade 16 in the second closed position.

In one configuration, the second engageable blade 16 may be positioned such that during transition of the engageable blades 14, 16 from the first open position to the second closed position, the second engageable blade 16 slides just above the first engageable blade 14 to provide a cutting force to an object positioned between the first and second engageable blades 14, 16, as shown in FIG. 1.

Referring specifically to FIG. 4, the first and second engageable blades 14, 16 are connected to a handle portion 12 that allows a user to impart a manual force to the handle portion 12 to transition the first and second engageable blades 14, 16 from the first open position to the second closed position, and to repeat this action as appropriate. In one embodiment, the handle portion includes a first handle portion 30 connected to the first engageable blade 14, and a second handle portion 32 connected to the second engageable blade 16. In a further configuration, the first handle portion 30 may be axially aligned with the first engageable blade 14 and the second handle portion 32 may be axially aligned with the second engageable blade 16. The first engageable blade 14 includes a pivoting portion 22 and the second engageable blade 16 includes a pivoting portion 22. The pivoting portion 22 of the first and second engageable blades 14, 16 are fastened together at a pivot, enabling a sliding transition between the first and second engageable blades 14, 16.

The first and second handle portions 30, 32 may each define a hole 34 therein adapted to allow a user to insert at least one finger through the hole 34 to operate the garden implement of the present invention and transition the first and second engageable blades 14, 16 from the first open position to the closed second position. In this aspect, the gardening implement of the present invention is capable of performing a cutting action, as is shown in FIG. 1.

In a further configuration, the first and second engageable blades 14, 16 each include a tip portion 20 and a pivoting portion 22 with a thickened region 24 disposed therebetween. In one embodiment, the thickened region 24 has a generally curved profile, such as a generally concave profile extending between the tip portion 20 and the pivoting portion 22. When the first and second engageable blades 14, 16 are in the second closed position, the thickened region 24 of the first engageable blade 14 and the thickened region 24 of the second engageable blade 16 may be adapted to form a scoop suitable for holding dirt, and other like material, therein. The thickened region 24 may have a generally semi-circular cross-section, a generally curved, such as concave-up, cross-section, or a cross-section having a variety of differently curved regions. In a further embodiment, the thickened region 24 of the first and second engageable blades 14, 16 is substantially identical. Optionally, the garden implement may include a locking element for securing the first engageable blade 14 with the second engageable blade 16.

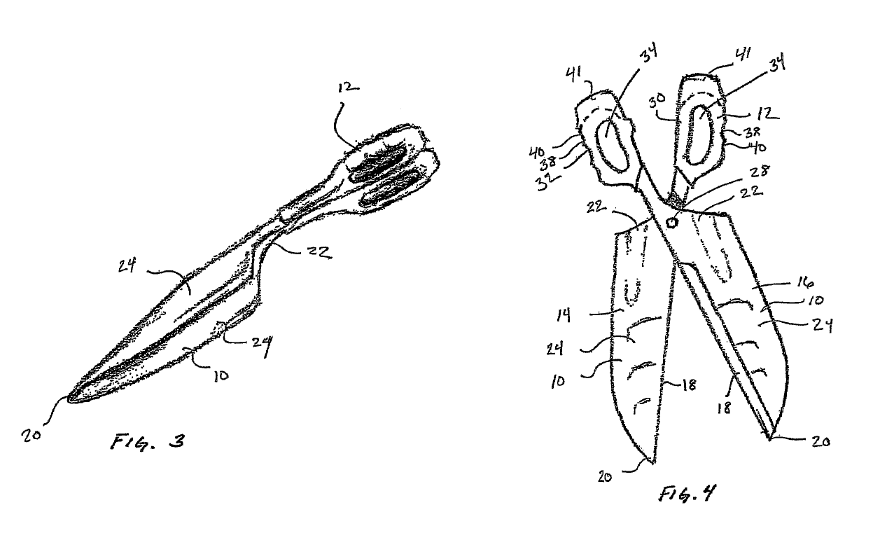

The engaged digging tip portion of the garden implement, formed when the first tip portion of the first engageable blade 14 is in contact with the second tip portion of the second engageable blade 16, of the present invention may include a pointed region for providing an edge suitable for digging in garden dirt. This feature, combined with the scoop feature formed by the first and second engageable blades 14, 16 in the second closed position enables a user to utilize the first and second engageable blades 14, 16 to perform a digging action when the first and second blades 14, 16 are in the second closed position, as shown in FIG. 2.

Referring again to FIG. 4, the handle 12 of the garden implement of the present invention may include a grippable region 40 disposed along an outer surface 38 of the first and second handle portions 30, 32. In one embodiment, the grippable region 40 includes a plurality of indentations corresponding to the fingers of a user to enable a user to grasp the handle to apply a downward digging force to the blade portion 10. In this configuration, the user will remove their fingers from the holes 34 in the first and second handle portions 30, 32 and grasp both the first and second handle portions 30, 32 in the closed position while inserting their fingertips in the grippable region 40. In a further configuration, the grippable region 40 may include a tackifier, foam cushioning, or other padding for increasing comfort to a user when grasping the handle portion 12 for digging. In yet a further configuration, the handle portion 12 may include an extended portion 41, disposed on each of the first and second handle portions 30, 32. This extended portion 41 may include a thickened region having an increased profile to enable a user to position a portion of the palm of the hand against the handle 12 of the garden implement to further facilitate a digging action.

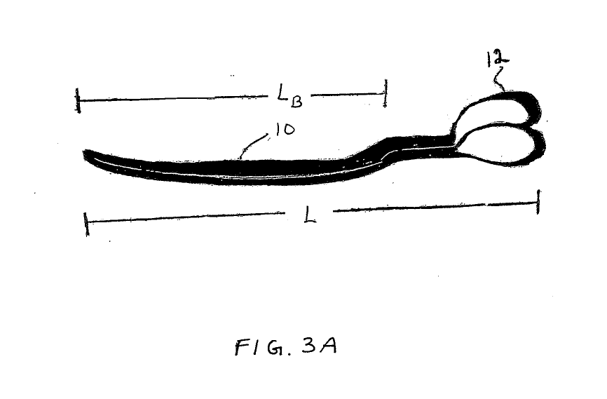

As shown in FIG. 3A, the blade portion 10 of the garden implement may be considerably longer than the handle portion 12. In one embodiment, the length L_{B} of the blade portion 10 may be from about 60% to about 80% the overall length L of the garden implement.

As shown in FIG. 4A, during operation of the garden implement to achieve a cutting action, a user will apply force to the handle portion 12 in the direction of arrows A in order to transition the first and second engageable blades 14, 16 from the first open position to the second closed position, as shown in FIGS. 5-6. A user will then subsequently apply force to the handle portion 12 in the direction of arrows B in order to transition the first and second engageable blades 14, 16 from the second closed position to the first open position in order to re-open the blade portion 10 for a subsequent cutting action.

As shown in FIG. 4B, during operation of the garden implement to achieve a digging action, a user will apply force to the handle portion 12 in the direction of arrows C in order to apply a downward digging force on the tip portion 20 to pierce the ground.

What is claimed is:

1. A gardening implement, comprising:
a blade portion comprising a first engageable blade having a first sharpened region extending between a first tip portion and a pivot, and a second engageable blade having a second sharpened region extending between a second tip portion and the pivot, wherein the first engageable blade and the second engageable blade are pivotally connected at the pivot;
wherein each of the first sharpened region and the second sharpened region comprise a thickened region having a concave curved profile, and wherein when the first sharpened region of the first engageable blade is provided in contact with the second sharpened region of the second sharpened blade, the blade portion forms a scoop,
wherein when the first tip portion of the first engageable blade is provided in contact with the second tip portion of the second engageable blade the engaged first tip portion and second tip portion of the blade portion form a digging tip portion; and
a handle portion connected to the blade portion, the handle portion comprising a first handle portion connected to the first engageable blade and a second handle portion connected to the second engageable blade,
wherein the handle portion defines a first grasping portion defined within a portion of the first handle portion and the second handle portion, and comprises a second grasping portion disposed along an outer surface of the first handle portion and an outer surface of the second handle portion.

2. The gardening implement of claim 1, wherein when the first sharpened region of the first engageable blade is provided in contact with the second sharpened region of the second sharpened blade, the blade portion forms a generally semi-spherical cross-section.

3. The gardening implement of claim 1, wherein the first grasping portion defines an opening hole in the first handle portion suitable for receiving a user's finger therein, and further defines a second opening hole in the second handle portion suitable for receiving a user's finger therein.

4. The gardening implement of claim 1, wherein the second grasping portion comprises a grippable region having a plurality of indentations for receiving a user's fingers therein.

5. The gardening implement of claim 1, wherein the second grasping portion comprises a tackifier.

6. The gardening implement of claim 1, wherein the second grasping portion comprises foam padding.

7. The gardening implement of claim 1, wherein the first handle portion comprises an extended portion and the second handle portion comprises a second extended portion, each of the extended portion and the second extended portion having a thickened region for receiving a user's palm.

8. The gardening implement of claim 1, wherein the blade portion is longer than the handle portion.

9. The gardening implement of claim 8, wherein the blade portion and the handle portion taken together define an overall length and a length of the blade portion is from about 60% to about 80% of the overall length of the blade portion and handle portion taken together.

10. The gardening implement of claim 1, wherein the first sharpened region and the second sharpened region are adapted for cutting garden material.

11. The gardening implement of claim 1, wherein the scoop is adapted for holding dirt or other like material.

12. The gardening implement of claim 1, wherein the digging tip portion is suitable for penetrating soil.

13. The gardening implement of claim 1, wherein the handle portion includes a generally flattened region for allowing a user's palm to be pressed thereagainst.

14. The gardening implement of claim 1, wherein each of the first engageable blade and the second engageable blade comprises a generally straightened region and a curved region.

15. The gardening implement of claim 14, wherein the generally straightened region is adjacent the pivot.

16. The gardening implement of claim 14, wherein the first engageable blade comprises the curved region adjacent the first tip portion and the second engageable blade comprises the curved region adjacent the second tip portion.

17. The gardening implement of claim 1, wherein the first engageable blade and the second engageable blade each comprise a thickened region having the same concave curved profile.

18. The gardening implement of claim 1, wherein the first engageable blade comprises a thickened region having a first concave curved profile and the second engageable blade comprises a thickened region having a second concave curved profile, wherein the first concave curved profile is different from the second concave curved profile.
